(19) United States
(12) Patent Application Publication
(10) Pub. No.: US 2015/0136710 A1
(43) Pub. Date: May 21, 2015

(54) PHOTOCHEMICAL PROCESS FOR THE LIQUID PHASE DESTRUCTION OF POLYCHLORINATED BIPHENYL COMPOUNDS, POLYCHLORINATED DIBENZO-p-DIOXIN, AND POLYCHLORINATED DIBENZOFURAN CONTAMINATED SLUDGES AND SOILS

(71) Applicant: Air Control Techniques, P.C., Cary, NC (US)

(72) Inventor: John R. Richards, Durham, NC (US)

(73) Assignee: AIR CONTROL TECHNIQUES, P.C., Cary, NC (US)

(21) Appl. No.: 14/543,247

(22) Filed: Nov. 17, 2014

Related U.S. Application Data
(60) Provisional application No. 61/905,356, filed on Nov. 18, 2013.

(51) Int. Cl. C02F 11/00; B09C 1/08; C02F 11/12

(52) U.S. Cl. CPC C02F 11/004; C02F 11/12; B09C 1/08; C02F 2101/363
USPC 210/748.13; 405/128.75

(57) ABSTRACT

A method or process is provided for treating contaminated sludge or soil that includes adsorbed polychlorinated biphenyl compounds (PCB) and polychlorinated dibenzo-p-dioxins and polychlorinated dibenzofurans (collectively termed “dioxin-furans compounds”), the method includes pulverizing the sludge or soil and thereafter directing the sludge or soil to an extraction tank where the PCB and dioxin-furan compounds are extracted from the sludge or soil and are caused to become dissolved in a solvent. The treated sludge or soil is separated from the solvent and the solvent is subjected to an ultraviolet irradiation process that destroys the PCB and dioxin-furan compounds.

### CROSS-REFERENCE TO RELATED APPLICATIONS

The present application is a non-provisional application of U.S. Provisional Patent Application Ser. No. 61/905,356 filed Nov. 18, 2013, the disclosure of which is hereby expressly incorporated by reference.

### FIELD OF INVENTION

The present invention relates to a process for destroying polychlorinated biphenyl compounds (hereafter termed “PCB”) in contaminated sludge present in waste water sludge ponds, industrial waste lagoons, lakes, and rivers and also present in some soils. The present invention also destroys tetra- through octa-substituted polychlorinated dibenzo-p-dioxins and polychlorinated dibenzofurans (hereafter collectively termed “dioxin-furans”) that are often present in sludge and soil with PCBs.

### BACKGROUND OF THE INVENTION

Large quantities of PCBs have been discharged into industrial wastewater ponds and lagoons of facilities that ceased operations in the 1960s and 1970s. Some of the PCB-contaminated wastes have entered lakes, streams, and rivers. The PCBs are lipophilic, non-volatile organic compounds that readily adsorb on the surfaces of sludge, clay, and organic particles, especially those composed of non-polar substances. Once adsorbed on the surfaces of sludge or clay particles, the PCBs remain for long time periods. International environmental organizations have labeled PCBs as persistent organic pollutants (POPs) due to the chemical and physical stability of the PCBs in a solid form under ambient conditions.

There are 209 separate compounds that are termed PCBs. All of these compounds have a double benzyl ring with varying number of chlorine substitutes. The physical properties and chemical reactions of these 209 compounds vary, in part, due to the number and arrangement of the chlorine atoms. It is common to have a mixture of PCB compounds in any contaminated wastewater sludge or soil. PCB compounds, especially those with four or more chlorine atoms on the molecule, are resistant to microbial destruction.

Dioxin-furan compounds are often present with PCBs compounds due to simultaneous formation of PCBs and dioxin-furans in industrial processes and due to the oxidation of PCB compounds to form dioxin-furans. There are 210 difference dioxin-furan compounds all having a tri-cyclic ring structure with two biphenyl groups linked by oxygen molecules.

Presently, it is difficult to dispose of PCB and dioxin-furan-containing sludges and wastewater in industrial ponds and lagoons. The most common treatment technique for the PCB and dioxin-furan-containing wastes is dredging the pond or lagoon and either incinerating the sludge on-site or shipping of the sludge to an off-site thermal incineration facility. The incineration-related disposal costs are extremely expensive. The dredge-transport-burn approach creates risks of PCB and dioxin-furan contamination of the excavation site and the shipping routes. A second treatment approach involves capping of the wastewater pond or lagoon with impermeable material to trap the PCB and dioxin-furan compounds in place. It would be more environmentally sound and economically reasonable to destroy the PCBs and dioxin-furans in-situ rather than to use the dredge-transport-burn or capping treatment approaches.

A variety of researchers are investigating the use of microbial species that can consume the PCB compounds. These processes involve adsorption of the microbes on the surfaces of adsorbents such as activated carbon and char, which are then released into the PCB-containing sludge. However, these microbial-based solutions have a number of significant challenges including (1) transport of the microbes to the high concentration PCBs in the deep sludge layers, (2) survival of the microbes during cold weather periods, and (3) survival of the microbes exposed to highly chlorinated PCB compounds. The difficulties associated with these approaches are indicated by the fact that PCB contaminated sludges and other wastes have existed for more than forty years in many locations. If microbes were effective in destroying this type of material it seems likely that the levels of PCBs would have decreased over this long period. It is also important to note that little attention has been devoted to the possibility that low level microbial action can generate increased dioxin-furans.

There is increasing interest on the part of both industrial facilities and regulatory agencies to destroy PCBs and dioxin-furans in industrial wastewater ponds and lagoons. There is concern that PCBs and dioxin-furans could be released due to flooding of the wastewater pond or lagoon, or that the PCBs and dioxin-furans could leach into the ground-water. There is a need for an environmentally sound and economical procedure to destroy PCBs and dioxin-furans on-site.

### SUMMARY OF THE INVENTION

The present invention relates to a method or process for treating contaminated sludge or soils having adsorbed PCB and dioxin-furan compounds. The method includes mixing the contaminated sludge or soil with a solvent in an extraction tank and extracting PCB and dioxin-furan compounds from the contaminated sludge or soil. The extracted PCB and dioxin-furan compounds are dissolved in the solvent. The treated sludge or soil is removed from the solvent and the solvent is subjected to an ultraviolet irradiation process which destroys the PCB and dioxin-furan compounds in the solvent. As an option, the treated solvent can be returned and utilized to extract additional PCB and dioxin-furan compounds from the contaminated sludge or soil.

Specifically, in one embodiment, the process is directed to (1) filtering the sludge and/or water as necessary to recover solids with adsorbed PCB and dioxin-furan compounds, (2) desorbing the PCB and dioxin-furan compounds from the surfaces of filtered solids using extraction into mineral oil (3) filtering of the extraction-treated solids from the mineral oil solution, (4) return of the filtered water and filtered/extraction treated solids back to the wastewater lagoon, (5) UV irradiation of the filtered mineral oil solution with dissolved PCB and dioxin-furans, and (6) recycling of the irradiated mineral oil solution back to the extraction tank.

A rotary vacuum filter or equivalent is a part of the process in one embodiment. It removes the large quantity of water that is present with the PCB and dioxin-furan compounds adsorbed on solid surfaces in the contaminated sludge. Due to the insolubility of PCBs and dioxin-furans in water, the filtered water has negligible levels of PCBs and dioxin-furans and the water can be returned to the wastewater sludge pond, industrial waste lagoon, lake, or river. When the PCBs and dioxin-furan compounds are present exclusively on dry or nearly dry solids and soils, the first rotary vacuum filter or equivalent is not needed as part of the process system.

Extraction of the PCBs and dioxin-furan compounds using a non-polar organic solvent such as mineral oil is a part of the process in one embodiment. PCBs and dioxin-furans are lipophilic materials that adsorb on the surfaces of organic material present in the solids. An organic solvent is used to desorb the PCB and dioxin-furan compounds. Due to the high Van der Waal forces associated with the high molecular weight aliphatic hydrocarbons in mineral oil, it is a good solvent for desorbing the PCBs and dioxin-furans from the surfaces of soil and sludges. The mineral oil in the extraction tank, in one example, is maintained at a rate of 0.5 to 3 gallons per pound of pulverized/ground soil or sludge entering the extraction tank. To increase the efficiency of PCB and dioxin-furan desorption from solids it is advantageous to heat the extraction process to a temperature not exceeding 150° F. Minimization of heating of the filtered solids to 150° F. during mineral oil extraction is desirable to avoid the conversion of PCBs into additional dioxin-furan compounds and to avoid volatilization of the mineral oil.

The efficiency of desorption of PCBs and dioxin-furans is a consideration. The present process, in one embodiment, uses a pulverizer after the solids rotary vacuum filter to reduce the size of the solids particles to a mass median size of less than 100 micrometers and a maximum size of equal to or less than 300 micrometers. The high particle surface area of particles in this size range allow for effective contact between the mineral oil extraction solution and the PCBs and dioxin-furans adsorbed on the surfaces of these particles. To further enhance PCB and dioxin-furan desorption, the solution is heated to a maximum of 150° F. to overcome the weak bonding adsorption forces.

Following the extraction process, the mineral oil solution and entrained particles are sent to a second rotary vacuum filter or equivalent (i.e., other suitable filtering devices). Solid particles are removed and sent back to the wastewater lagoon or pond. The mineral oil solution with dissolved PCBs and dioxin-furans is sent to a photochemical irradiation vessel.

In the irradiation vessel, the PCBs and dioxin-furans are exposed to UV light emitted from an array of UV lamps. The lamps emit light in an effective spectral range of 180 to 380 nanometers. The intensity of the emitted UV light in the effective spectral range is designed, in one embodiment, based on a quantum yield of 0.001 to 0.10 for combined PCBs and dioxin-furans. The residence time, in one embodiment, in the irradiation tank varies from approximately 1 to approximately 5 minutes depending primarily on the concentration of PCBs and dioxin-furans in the mineral oil solution.

The present process is unique in that PCB and dioxin-furan compounds adsorbed on the surfaces of solid phase organic material are desorbed and solvent extracted using mineral oil or another suitable solvent and thereby transferred to a liquid phase form where effective contact with UV light is possible in a vessel with a long residence time designed to maximize UV light absorption by PCB compounds.

The present process is unique in that the desorption of PCB and dioxin-furan compounds is enhanced by grinding the filtered or unfiltered solids to a small size range and by heating the soil or sludge particles, in one embodiment, to a maximum of 150° F.

The present process is unique with respect to the use of UV light in the spectral range of 180 to 380 nanometers to initiate dechlorination and cleavage of the biphenyl rings of the PCB and the dioxin-furan compounds.

### BRIEF DESCRIPTION OF DRAWING

FIG. 1 is a schematic illustration of the method or process of the present invention.

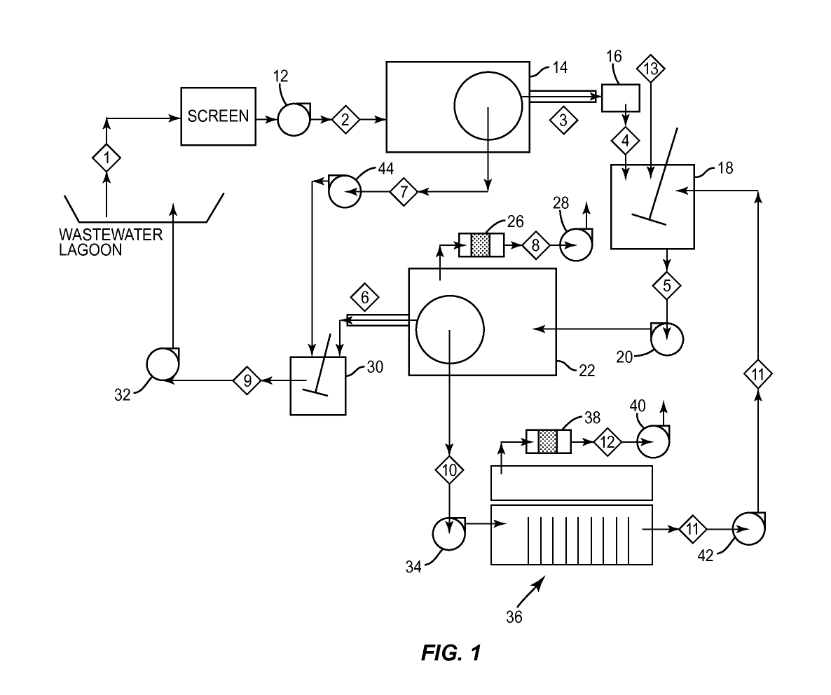

### DETAILED DESCRIPTION OF THE INVENTION

The present process, in one embodiment, removes PCB and dioxin-furan contaminated sludges or soils from their source location, filters the solids as necessary to remove water, extracts PCBs and co-present dioxin-furans from the solids using a solvent such as mineral oil, and employs UV treatment of the PCBs and dioxin-furans in the solvent or mineral oil solution. The filtered water and treated sludge is returned to the source location.

Contaminated sludge, for example, is removed from a wastewater pond, lagoon, lake or river using Diaphragm Pump 12. Sludge is pumped (stream 1) into a Screen to remove large objects that could damage the diaphragm pump 12. The sludge-water mixture is then pumped by Diaphragm Pump 12 (stream 2) into a filter such as a Rotary Vacuum Filter 14. The partially dried sludge or soil having a water content of approximately 10%-35% by weight is then conveyed (stream 3) to a Pulverizer 16. Pulverizer 16, in one embodiment, increases the exposed surface of the sludges or soils by reducing the sizes of the sludge or soil particles to a mass median diameter of 100 micrometers and a maximum size of 300 micrometers. Following size reduction, the filtered sludge and/or soil is discharged (Stream 4) into an extraction tank 18.

Filtered water from Rotary Vacuum Filter 14 is transported (stream 7) to a Mixing Tank 30 using Centrifugal Pump 44. This water has negligible PCB and dioxin-furan content due to the extremely low water solubility of these compounds.

The PCB and dioxin-furan containing sludge particles mix with a solvent such as mineral oil in the extraction tank 18 to transfer these compounds to the liquid solvent or mineral oil solution. Mineral oil, for example, is a desirable solvent due to its non-polar molecular structure, the high Van der waal adsorption forces possible, its low volatility, and its low flammability. It is generally more effective than n-hexane (an aliphatic compound that is smaller than the alipathic compounds in mineral oil) used for high efficiency desorption in laboratory procedures used to extract PCBs and dioxin-furan compounds.

Extraction tank 18 has a solution residence time, in one embodiment, of between 2 to 10 minutes to allow for desorption of the PCBs and dioxin-furans. Extraction tank 18 is heated using either hot water immersion coils and/or external side wall electrical heaters to maintain a solution temperature between 100° F. to 150° F. The maximum temperature, in one embodiment, is maintained below 150° F. to avoid PCB reactions to form additional dioxin-furans and to minimize volatilization of the mineral oil from the solution.

The mineral oil solution with the suspended sludge and/or soil particles is transported (stream 5) to rotary vacuum filter 22 using diaphragm pump 20. The mineral oil with dissolved PCBs and dioxin-furans is separated from the treated sludge solids in this filter. The partially dried solids are conveyed to the mixing tank 30 where they mix with the filtered water from rotary vacuum filter 14. The filtered water and treated sludge solids are mixed and returned (stream 9) to the wastewater lagoon or other source location using diaphragm pump 32. The water and sludge particles return to the isolated cell being treated.

The filtered mineral oil solution with dissolved PCBs and dioxin-furans is then transported (stream 10) to the irradiation chamber 36 using centrifugal pump 34. In the irradiation chamber 36 the PCBs and dioxin-furan compounds are destroyed due to absorption of ultraviolet light in the effective spectral range of 180 to 380 nanometers. Following irradiation, the mineral oil is returned to the extraction tank 18 for contact with filtered sludge solids. A solvent or mineral oil make-up stream (stream 13) replaces any mineral oil volatilized in the process or remaining with the solids returning to the wastewater lagoon or other source location.

Small activated carbon canisters 26 and 38 are used to ventilate rotary vacuum filter 22 and the irradiation chamber 36. The air flow rates are maintained by centrifugal fans 28 and 40. The gas flow rates are maintained at rates sufficient to maintain the volatilized mineral oil and/or other non-polar solvent concentrations at less than about 10% of the lower explosive limit in air. When the activated carbon canisters are exhausted, these are dumped into a section of the wastewater lagoon to be treated.

The UV lamps and their quartz envelopes are suspended from an upper support frame near the top of the irradiation chamber 36.

Amalgam mercury vapor lamps generate UV light primarily in the 185 and 254 nanometer wavelengths. Medium pressure mercury lamps generate UV light in the 200 to 380 nanometer spectral range. Absorption of the UV light in these spectral bands results in cleavage of the biphenyl ring structures and dechlorination of biphenyl compounds. The cumulative results of UV light absorption in this spectral range is the high efficiency destruction of the PCB compounds and the formation of a variety of reaction products at concentrations well below the concentrations classified as toxic.

The residence time of the PCB-containing gas stream in the irradiation chamber 36 is maintained, in one embodiment, at 1 to 5 minutes to maximize the efficiency of PCB destruction. The intensity of UV energy used for PCB destruction is determined based on a quantum yield ranging from 0.001 to 0.10 calculated based on the total concentration of PCBs and dioxin-furans. This design basis collectively takes into account the concentration of PCBs and dioxin-furans in the gas stream, the mixture of PCB and dioxin-furan compounds, the geometry of the irradiation vessel, the gas stream residence time in the irradiation vessel, and the output intensity of the UV lamps.

The performance of the photochemically-based PCB destruction system is monitored by a set of UV radiometers in the irradiation chamber 36 and by routine sampling and analysis of the discharged solids using high resolution gas chromatography/high resolution mass spectrometry in accordance with EPA method 8290 or SW846 8082A and by routine sampling and analysis of the sludge solids being returned to the wastewater lagoon and the treated cell using method SW 846 Method 0031 in combination with EPA Method 8290.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

It is claimed:

1. A method of treating contaminated sludge having adsorbed PCB and dioxin-furan compounds wherein the sludge includes contaminated sludge particles comprising:
removing water from the contaminated sludge;
increasing the surface area of the contaminated sludge particles;
after removing water from the contaminated sludge and increasing the surface area of the sludge particles, mixing the sludge particles with a solvent and extracting the PCB and dioxin-furan compounds from the sludge particles into the solvent to produce treated sludge particles;
after extracting the PCB and dioxin-furan compounds from the contaminated sludge particles, filtering the solvent to remove the treated sludge particles; and
after removing the treated sludge particles from the solvent, destroying the PCB and dioxin-furan compounds in the solvent by irradiating the solvent with ultraviolet light.

2. The method of claim 1 including mixing the contaminated sludge particles with mineral oil and extracting PCB and dioxin-furan compounds from the contaminated sludge particles into the mineral oil.

3. The method of claim 1 including recycling the irradiated solvent and utilizing the irradiated solvent to extract PCB and dioxin-furan compounds from additional contaminated sludge particles.

4. The method of claim 1 including mixing the contaminated sludge particles with a non-polar organic solvent and extracting PCB and dioxin-furan compounds from the contaminated sludge particles into the non-polar organic solvent.

5. The method of claim 1 including mixing the contaminated sludge particles and solvent in an extraction tank and generally maintaining approximately 0.5-3.0 gallons of solvent per pound of contaminated sludge particles in the extraction tank.

6. The method of claim 1 including mixing the contaminated sludge particles and solvent in an extraction tank and heating the solvent in the extraction tank to a temperature not exceeding 150° F.

7. The method of claim 1 including:
mixing the contaminated sludge particles and solvent in an extraction tank;
heating the solvent in the extraction tank to a temperature of 100° F. to 150° F.;
wherein the solvent mixed with the contaminated sludge particles is a non-polar organic solvent; and
wherein the method includes irradiating the solvent with UV light in an effective spectral range of 180-380 nanometers.

8. The method of claim 1 including pulverizing the contaminated sludge and reducing the size of the sludge particles comprising the sludge to a mass median size of less than 100 micrometers and a maximum size equal to or less than 300 micrometers.

9. The method of claim 1 including irradiating the solvent with UV light in an effective spectral range of 180-380 nanometers.

10. The method of claim 9 wherein the intensity of the emitted UV light is based on a quantum yield of 0.001-0.1.

11. The method of claim 1 including holding the solvent in an irradiation tank during irradiation for a residency time of approximately 1 to approximately 5 minutes.

12. A method of treating contaminated soil having PCB and dioxin-furan compounds adsorbed thereon, the method comprising:
pulverizing the contaminated soil;
mixing the pulverized contaminated soil with a solvent in an extraction tank and extracting PCB and dioxin-furan compounds from the contaminated soil and causing the PCB and dioxin-furan compounds to become dissolved in the solvent and in the process producing treated soil;
separating the treated soil from the solvent; and
after separating the treated soil from the solvent, destroying the PCB and dioxin-furan compounds dissolved in the solvent by irradiating the solvent with ultraviolet light.

13. The method of claim 12 including heating the solvent in the extraction tank to a temperature of 100° F. to 150° F.; and recycling the irradiated solvent back to the extraction tank for use in striking PCB and dioxin-furan compounds from contaminated soil.

14. The method of claim 13 including mixing mineral oil with the contaminated soil and extracting PCB and dioxin-furan compounds from the contaminated soil and dissolving the PCB and dioxin-furan compounds into the mineral oil.

15. The method of claim 12 including pulverizing the contaminated soil whereas to reduce the size of soil particles through a mass median diameter of 100 micrometers to 300 micrometers.
